(19) United States
(12) Patent Application Publication
(10) Pub. No.: US 2008/0014065 A1
(43) Pub. Date: Jan. 17, 2008

(54) Lifting and carrying cradle

(76) Inventor: Thomas J. Bilinovich, Clinton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/486,812

(22) Filed: Jul. 14, 2006

(51) Int. Cl. B60P 9/00

(52) U.S. Cl. 414/462

(57) ABSTRACT

A cradle for use with a motorized vehicle for lifting and carrying a load. The cradle includes a mounting member that is secured to back end of a motorized vehicle; a platform on which the load is to be carried and inner and outer mounting rods that connect the mounting member and platform together. The inner and outer mounting rods are adjustable in length. A pair of spaced apart, adjustable length lower support members are connected to the mounting rods and extend forward beneath the platform to support the same. The lower support members include an arcuate portion that extends in front of the peripheral wall of the platform to retain a load carried thereon and prevent it from falling off the vehicle. A pair of spaced apart second members are connected to the inner and outer mounting rods at a height above the platform. The second members are also adjustable in length and aid in keeping the load on the top of the platform. The cradle is foldable for storage purposes.

### BACKGROUND OF THE INVENTION

1. Technical Field

This invention generally relates to lifting devices. More particularly, the invention relates to a lifting device for attachment to a vehicle. Specifically, the invention relates to a lifting and carrying rack for attachment to an all terrain vehicle that can be raised or lowered relative to the ground, that includes adjustable length components to accommodate loads of different shapes and sizes.

2. Background Information

Hunters may cover fairly large areas of land in their quest for deer. They will therefore frequently use all terrain vehicles (ATV's) to cover these tracts of land and to get further away from towns and more populated rural areas. However, once they have managed to shoot a deer, the distance covered in the initial search presents a problem for the return journey in that the carcass of the deer has to be carried in some manner. The deer may be tied onto the all terrain vehicle, but this is cumbersome and difficult to do and the ropes may work loose as the vehicle travels over the terrain. Furthermore, lifting the carcass onto the vehicle is a problem because of the dead weight involved.

There is therefore a need in the art for a device that can be mounted onto a vehicle, such as an all terrain vehicle, and that can easily lift a load from a position close to the ground to a suitable height, that aids in securing the load onto the vehicle and carrying the load over bumpy terrain.

### SUMMARY OF THE INVENTION

The device of the present invention constitutes a cradle for use with a motorized vehicle to lift and carry a load. The cradle includes a mounting member that is secured to back end of a motorized vehicle; a platform on which the load is to be carried and inner and outer mounting rods that connect the mounting member and platform together. The inner and outer mounting rods are adjustable in length. A pair of spaced apart, adjustable length lower support members are connected to the mounting rods and extend forward beneath the platform to support the same. The lower support members include an arcuate portion that extends in front of the peripheral wall of the platform to retain the load carried thereon and to aid in preventing it from falling off the vehicle. A pair of spaced apart second members are connected to the inner and outer mounting rods at a height above the platform. The second members are also adjustable in length and aid in keeping the load on the top of the platform. Furthermore, the cradle is designed to be foldable so that it does not extend too far outwardly away from the back end of the ATV when it is not being used to transport a load. When the device is correctly installed on the back end of the ATV, the center of gravity of the ATV is not adversely affected.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a side view of the lifting and carrying cradle in accordance with the present invention and shown attached to an all terrain vehicle;

FIG. 2 is perspective view of the lifting and carrying cradle in accordance with the present invention;

FIG. 3 is a top view of the lifting and carrying cradle;

FIG. 4 is partial cross-sectional side view through line 4-4 of FIG. 3;

FIG. 5 is a partial cross-sectional side view through line 5-5 of FIG. 3;

FIG. 6 is a partial cross-sectional side view through line 6-6- of FIG. 3;

FIG. 7 is a front view of the lifting and carrying cradle;

FIG. 8 is a partial cross-sectional side view through line 8-8 of FIG. 7;

FIG. 9 is a perspective view of the cradle in a folded position for storage;

FIG. 10 is a partial front view of the cradle in a folded position;

FIG. 11 is a perspective view of a second embodiment of the lifting and carrying cradle in accordance with the present invention; and

FIG. 12 is a front view of the cradle of FIG. 11 shown carrying a load thereon.

### DETAILED DESCRIPTION OF THE INVENTION

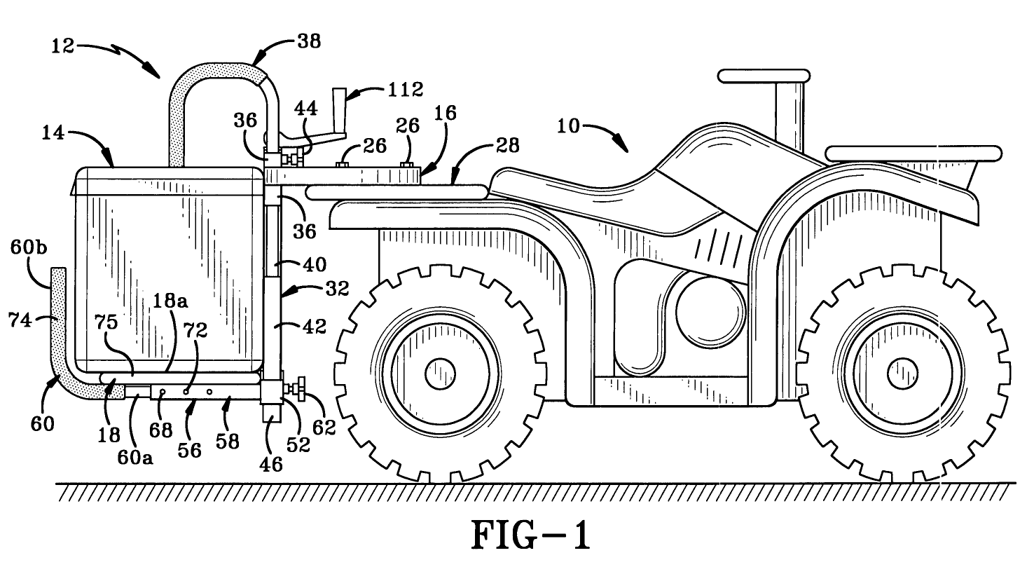

Referring to FIG. 1 there is shown an all terrain vehicle (i.e., an ATV) 10 onto which is attached a lifting and carrying cradle in accordance with present invention, said cradle being generally indicated at 12. Cradle 12 is shown carrying and retaining a load 14 thereon, the load in this instance being illustrated as a cooler so that the various components of the cradle 12 may be more easily seen.

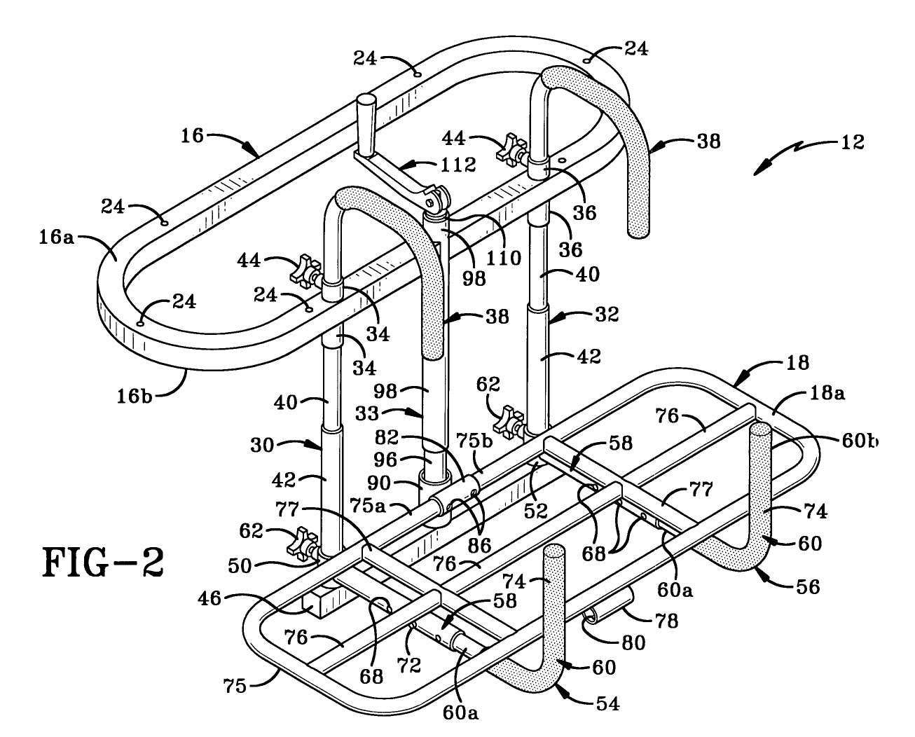

Referring to FIGS. 1-8, cradle 12 is secured to the vehicle 10 by a mounting member. In the preferred embodiment of the invention, that mounting member comprises a frame 16 that is generally elliptical in shape, although any other suitable shape may be utilized. Frame 16 includes a plurality of apertures 24 therein (FIG. 2) and through which a plurality of bolts 26 (FIG. 1) are inserted to secure frame 16 to the back end 28 of vehicle 10. It will be understood, however, that any other suitable connector, such as rivets, clamps, welds, etc., may be used to secure frame 16 to Vehicle 10.

A platform 18 is connected to frame 16 by way of one or more vertically oriented mounting rods 30, 32 and 33. Mounting rods, 30, 32, 33 are vertically adjustable relative to frame 16 and therefore are capable of lowering or raising platform through a vertical distance, as will be hereinafter described. Platform 18 is connected to the opposite side of mounting rods 30, 32, 33 from frame 16, both platform 18 and frame 16 extending outwardly away from rods 30, 32 and 33 in opposite directions from each other, but each being disposed at substantially right angles to mounting rods 30, 32, 33 when cradle 12 is in an open and operational position.

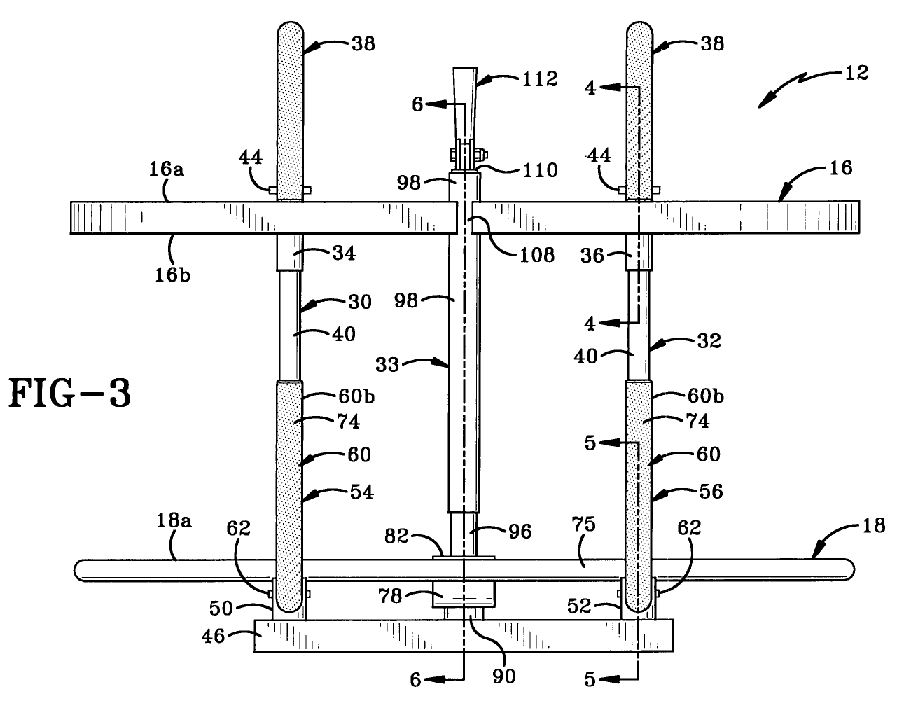

Platform 18 is generally rectangular in shape and includes a plurality of cross bars 20, 22 to provide a place on which the load 14 is placed. Platform 18 is suspended below frame 16 by a pair of spaced apart outer mounting rods 30, 32 which are each connected to frame 16 by way of short tubes 34, 36. Short tubes 34, 36 are inserted through an aperture 37 in frame 16, with a first region of short tubes 34, 36 being welded to upper surface 16a (FIG. 3) of frame 16 and a second region being welded to lower surface 16b of frame 16. Short tubes 34, 36 each include an axial bore 39 that is sized to receive a section of one of the outer mounting rods 30, 32 there through.

The outer mounting rods 30, 32 are substantially identical, each comprising a substantially U-shaped retaining member 38, a generally cylindrical second section 40 and a generally cylindrical third section 42. A first end of each retaining member 38 is received into the upper portion of one of short tubes 34, 36. Retaining members 38 are rotatable through 360° within the bore 39 of the respective short tube 34, 36 and are locked into a desired position by a rotatable, threaded spud 44. Spud 44 may be rotated to bring the end of shaft 45 thereof into contact with the exterior wall of retaining member 38 (FIG. 4). In this position, retaining member 38 is locked against rotation about the longitudinal axis “A” of the respective short tube 34 and 36. When the end of shaft 45 is not in contact with the exterior wall of retaining member 38, then retaining member 38 is free to rotate about longitudinal axis “A”.

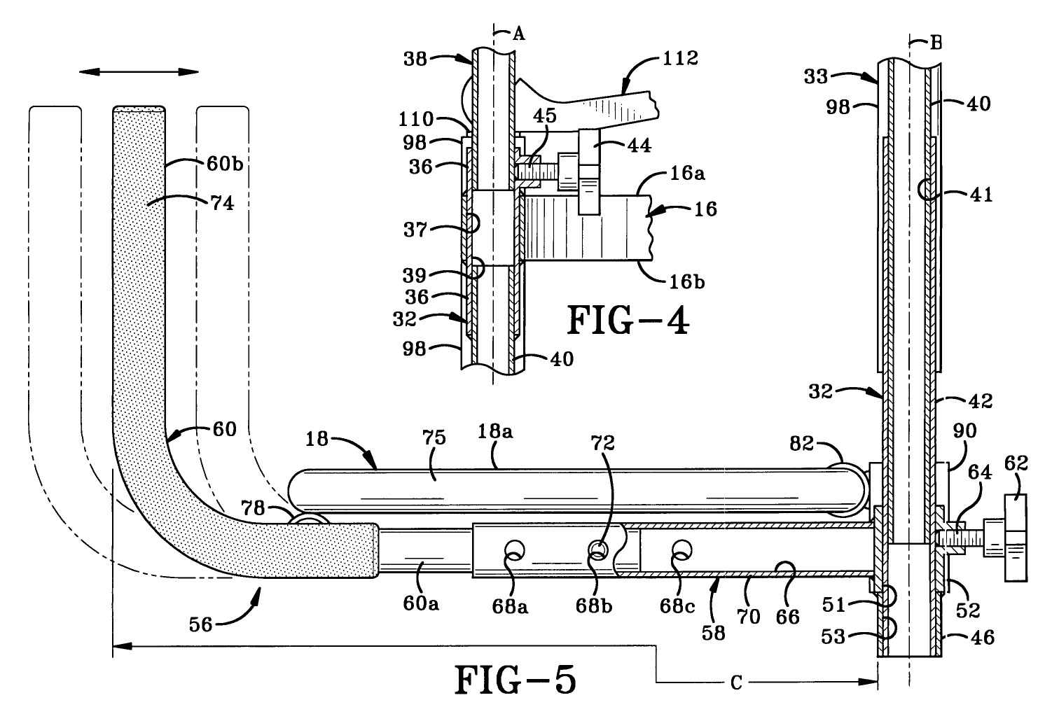

A first end of second section 40 is received with the bore 39 of the lower portion of each short tube 34, 36. As seen from FIG. 4, the ends retaining members 38 and second sections 40 do not contact each other within bore 39. Consequently, rotation of retaining member 38 does not necessitate rotation of second section 40, although the device could be manufactured in such a way that this could occur. A second end of second section 40 is slidably received within the bore 41 of third section 42 (FIG. 5). The second end of second section 40 can be inserted further into bore 41 of third section 42 to reduce the overall length of outer mounting rod 34 or 36, or can be withdrawn further outwardly from bore 41 to increase the overall length of the outer mounting rods 32, 34.

The third sections 42 of mounting rods 32, 34 are secured by short tubes 50, 52 to a support bar 46. Tubes 50, 52 are positioned on support bar 46 such that an axial bore 51 of each tube 50, 52 is aligned with one of a pair of spaced apart apertures 53 in bar 46. An end of each third section 42 is received through the aligned bore 51 and aperture 53. Short tubes 50, 52 are rotatable about the longitudinal axis “B” of third sections 42.

The underside of platform 18 is supported on a pair of spaced apart support members 54, 56 (FIG. 2). Support members 54, 56 are substantially identical to each another, each including a generally cylindrical first section 58 and a generally J-shaped second section 60. A first end of each first section 58 is welded to one of short tubes 50, 52. Consequently, if the associated short tube 52, 52 rotates about longitudinal axis “B”, then first section 58 rotates with it and visa versa. First section 58 can be rotated between a first position where it is disposed substantially parallel to support bar 46 and a second position where it is disposed substantially at right angles to support bar 46. The first section 58 can be locked in place by rotating the associated spud 62 in a direction that causes the threaded shaft 64 to engage third section 42 of one of outer mounting rods 30 or 32.

First section 58 of each support member 54, 56 includes an axial bore 66 (FIG. 5) and a plurality of holes 68, namely holes 68a, 68b and 68c, that extend through the exterior wall 70 thereof and into bore 66. A first end 60a of second section 60 is inserted into bore 66. First end 60a includes a projection 72 that is selectively received through one of the holes 68 in first section 58. The overall length “C” of each support member 54, 56 can be changed by engaging projection 72 in a different one of holes 68a, 68b and 68c. This causes the upwardly extending part 60b of second section 60 to be moved either toward or away from support bar 46 as is shown in phantom in FIG. 5. The upwardly extending part 60b preferably is covered with a sleeve 74 made from rubber, foam or some other non-slip protective material.

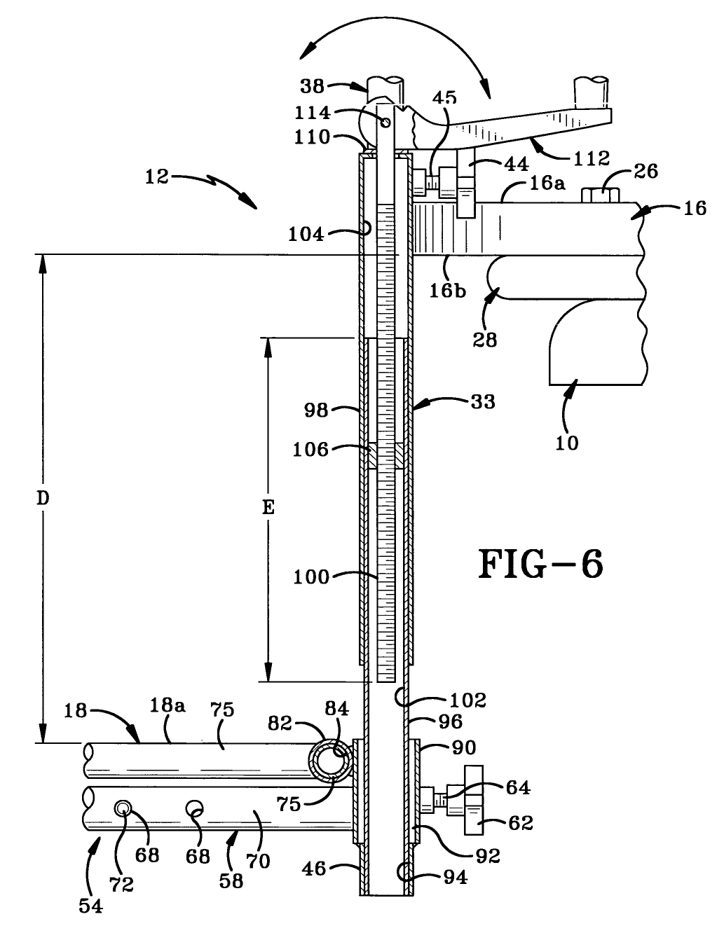

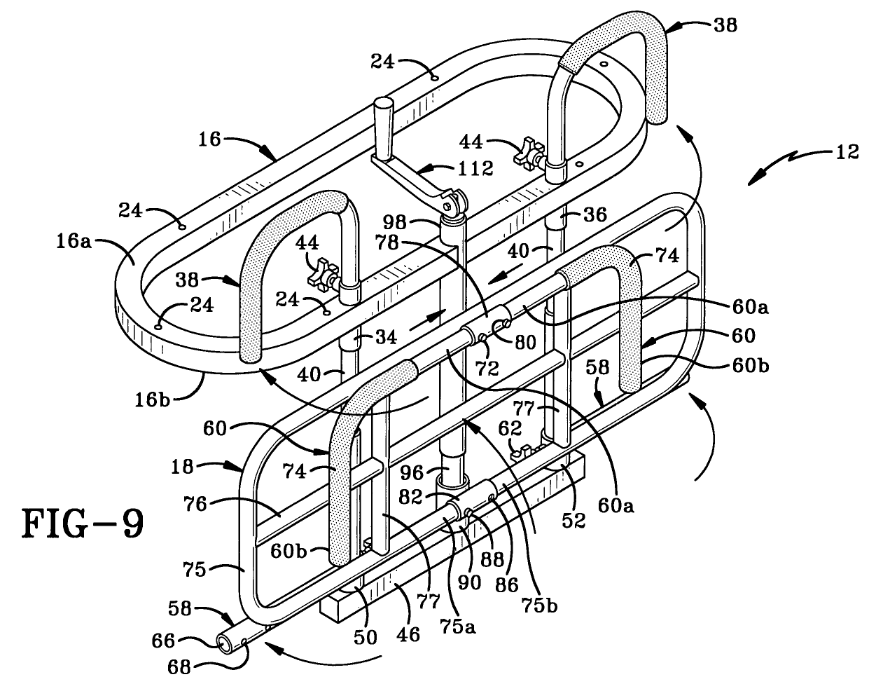

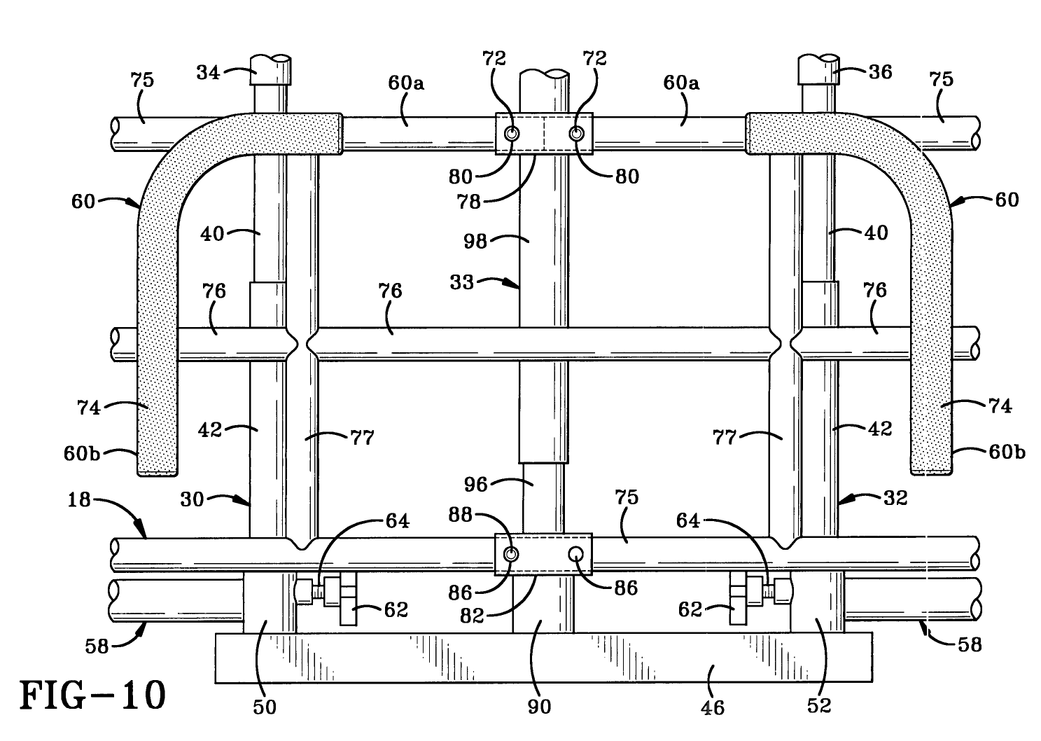

Platform 18 is shown in detail in FIG. 2. Platform 18 comprises a peripheral member 75 that is substantially rectangular in shape with rounded corners and having a plurality of cross-braces 76, 77 that extend from one part of peripheral member 75 to another. This forms a frame onto which load 14 can be placed. A holder 78 is welded onto a front lower surface of platform 15. Holder 78 is a substantially cylindrical tube that has an axial bore into which the first ends 60a of J-shaped sections 60 may be inserted for storage, as will be hereinafter described. Holder 78 further includes a pair of spaced apart apertures 80 that are sized and shaped to receive the projections on the first end 60a of J-shaped sections 60, as will be hereinafter described. Platform 18 is pivotally secured to support bar 46 via a second holder 82 that is welded to one of short tube 90 and support bar 46. Ends 75a, 75b of peripheral member 75 of platform 18 may be inserted into the bore 84 (FIG. 6) of second holder 82. Second holder 82 includes a pair of spaced apart apertures 86 (FIG. 9), at least one of which can receive a projection 88 from one of the ends 75a, 75b of peripheral member 75. This locks platform 18 in abutting contact with outer mounting rods 30, 32 and prevents platform 18 from being pivoted away therefrom.

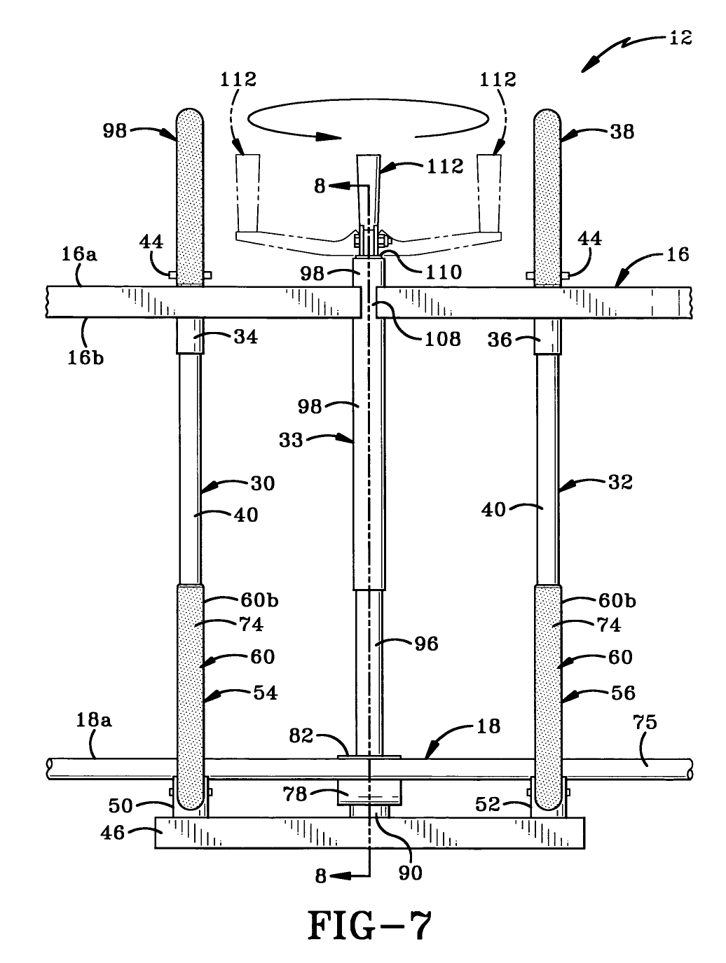

An inner mounting rod 33 also extends between frame 16 and support bar 46. Inner mounting rod 33 is disposed between outer mounting rods 32, 34 and comprises a telescoping vertical lower section 96 and upper section 98. Vertical lower section 96 is hollow and extends upwardly and outwardly from the bore 92 of short tube 90. The bore 102 of lower section 96 is coaxial with the bore 92 of short tube 90 and with the aperture 94 in support bar 46. Upper section 98 slides over an upper end of lower section 96 and a threaded rod 100 extends downwardly through bore 104 of upper section 98 and into bore 102 of lower section 96. A threaded spacer 106 is provided within bore 102 of lower section 96, spacer 106 being situated a short distance from the uppermost end of lower section 96. Spacer 106 preferably is secured to the interior wall of lower section 96 and rod 100 is treatably engaged with spacer 106 Upper section 98 is received through an aperture 108 in frame 16 and is welded to frame 16 in this region. The upper end of rod 100 extends outwardly from upper section 98, through a cap 110 and is connected to a handle 112 by a pivot rod 114. The handle 112 can be horizontally rotated through 360° as shown in FIG. 7, and as it rotates, it rotates rod 100 in the same direction. Handle 112 can also be partially rotated vertically as shown in FIG. 6 to orient it in a suitable position for storage or for use. The end of handle 112 that receives pivot rod 114 is rounded so that it slides easily over cap 110. When handle 112 is rotated vertically, then rod 100 remains stationary. When the length of inner mounting rod 33 is adjusted as described above, it will be understood that the telescoping outer mounting rods 30, 32 are passively changed in length and the handle 112 is rotated. In other words, as the upper portion 98 forces the lower portion 96 downwardly, the third sections 42 are also drawn downwardly as second sections 40 slide out of third sections 42.

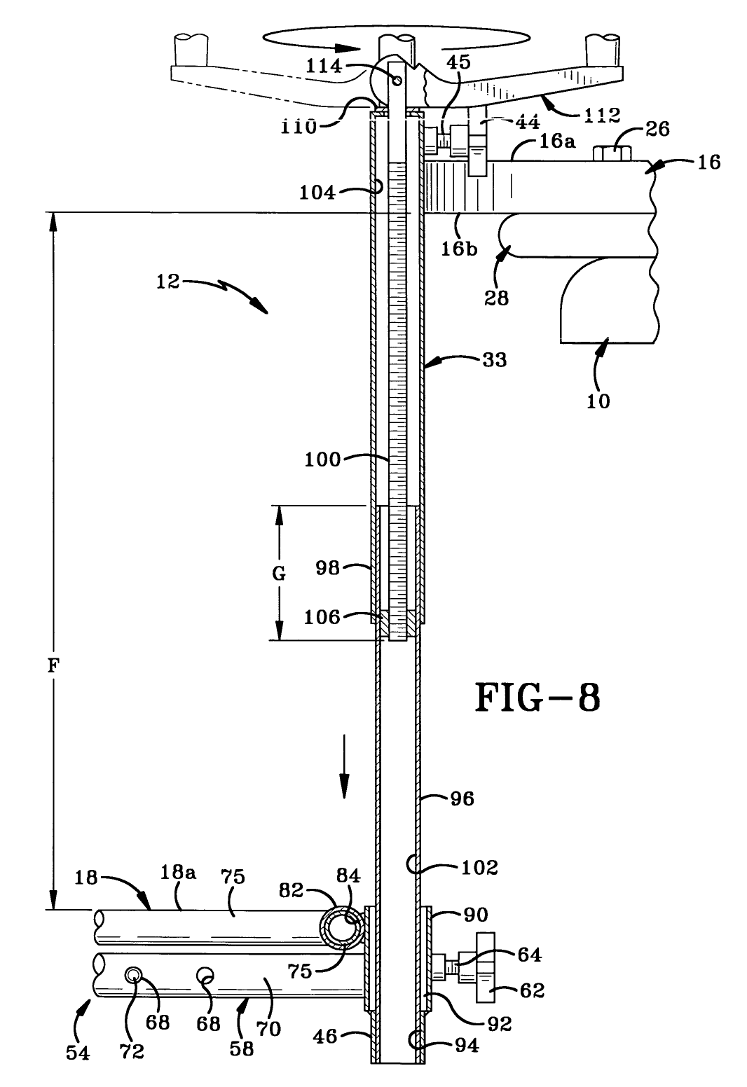

The cradle 12 of the present invention is used in the following manner. Cradle 12 is mounted onto the back end 28 of a vehicle 10 by way of a plurality of bolts 26 that are inserted through apertures 24 in frame 16. Once frame 16 is firmly secured to vehicle 10, platform 18 is lowered toward the ground so that it is easier to place load 14 thereon. The initial position of platform 18 is shown in FIG. 6. In this position, the upper surface 18a of platform 18 is spaced a distance “D” from the lower surface 16b of frame 16 and a length “E” of rod 100 extends through bore 102 of vertical lower section 96. The lowering of platform 18 is accomplished by the operator rotating handle 112 in an anticlockwise direction as shown in FIGS. 7&8. This anticlockwise rotation causes rod 100 to be progressively threaded through spacer 106. Spacer 106 is secured to lower section 96 and, consequently, lower section 96 is pushed downwardly out of the bore 104 of upper section 98 as indicated by the arrow in FIG. 8. This increases the distance between frame 16 and platform 18 from “D” to “F”. When platform 18 is in its lowermost position (FIG. 8), i.e., at its greatest distance away from frame 16 and closest to the ground, only a length “G” of rod 100 remains in lower section 96. At this point, it is also necessary to ensure that J-shaped portions 60 of support members 54, 56 are positioned appropriately to retain load 14 on platform 18. The distance between J-shaped portions 60 and outer mounting rods 30, 32 is adjusted by sliding the first ends of J-shaped portions 60 further inwardly into or outwardly from bores 66 of first sections 58. Projection 72 is depressed inwardly to allow this sliding motion on each respective bar 54, 56 and is then released to allow projection 72 to engage in the relevant one of apertures 68a, 68b, 68c (FIG. 5) and to thereby lock J-shaped portions 60 and first sections 58 together.

Once the appropriate distance between J-shaped portions 60 and outer mounting rods 30, 32 is set, then load 14 can be placed on upper surface 18a of platform 18. Support members 54, 56 serve to support platform 18 and thereby aid platform 18 in supporting load 14. Once load 14 is placed on platform 18 and support members 54, 56 have been adjusted so that J-shaped portions 60 are as close to the end face of load 14 as possible, then platform 18 is raised away from the ground and toward frame 16. Platform 18 and support members 54, 56 are raised to provide some clearance between them and the ground so that the motion of vehicle 10 is not hindered. In order to raise platform 18, handle 112 must be rotated in a clockwise direction. This clockwise rotation causes a clockwise rotation in rod 100 and causes rod 110 to be progressively threaded through spacer 106. As spacer 106 is secured to lower section 96, lower section 96 is drawn upwardly into bore 104 of upper section 98 and the length of rod 100 within lower section 96 increases from “G” to “E”. It will of course be understood that the relative distance between frame 16 and platform 18 can be altered to the degree needed by simply rotating the handle 112 in either a clockwise or anticlockwise direction until the correct position and orientation of load 14 is attained. The relative position of platform 18 and frame 16 is selected to allow the retaining members 38 of outer mounting rods 30, 32 to engage the top of load 14 (FIG. 1) and to thereby keep load 14 on platform 18 and aid in preventing load 14 from falling off cradle 12.

Vehicle 10 can then be driven over the terrain until the desired destination is reached. Load 14 is removed from cradle 12 by reversing the above steps. Handle 112 is rotated in an anticlockwise direction to lower platform 18 away from frame 16, This causes retaining members 38 of outer mounting rods 30, 32 to disengage from the top of load 14 and places platform 18 in a better position to lift load 14 from platform 18.

Once load 14 is removed, and if cradle 12 is no longer needed for transportation, then cradle 12 may be collapsed to store it against the body of the vehicle 10 as shown in FIGS. 9 & 10. Firstly, platform 18 is lifted to its uppermost position relative to frame 16. Then retaining members 38 of outer mounting rods 30, 32 are rotated inwardly so that the ends thereof are disposed over a part of frame 16. In order to permit this rotation, spuds 64 are rotated so that the ends of shafts 46 (FIG. 4) disengage from retaining members 38. Spuds 64 can then be rotated to lock retaining members 38 in this storage position.

Each J-shaped section 60 of support members 54, 56 is also disengaged from their associated first section 58 for storage. This is accomplished by depressing projection 72 inwardly and sliding the first end 60a of J-shaped section 60 out from the bore 66. The first end 60a of section 60 is inserted into one end of holder 78 and projection 72 engages an aperture in an aperture 80 in holder 78 to secure J-shaped section 60 therein. Platform 18 is then rotated upwardly so that its upper surface 18a abuts outer mounting rods 30, 32. Platform 18 is moved slightly horizontally until a projection 86 on peripheral member 75 slides into an aperture 86 on second holder 82. This locks platform 18 in position and prevents it from rotating downwardly back into a position where a load could be placed thereon. Spuds 62 are rotated so that the ends of shafts 64 thereof disengage from third sections 42 (FIG. 5) and thereby allow first sections 58 of support members 54, 56 to rotate into alignment over support bar 46. Spuds 62 are tightened once again to lock first sections 58 in this position. The cradle 12 is now in a suitable position for vehicle 10 to be driven. When the operator later wishes to use cradle 12 to transport another load 14, these steps are reversed.

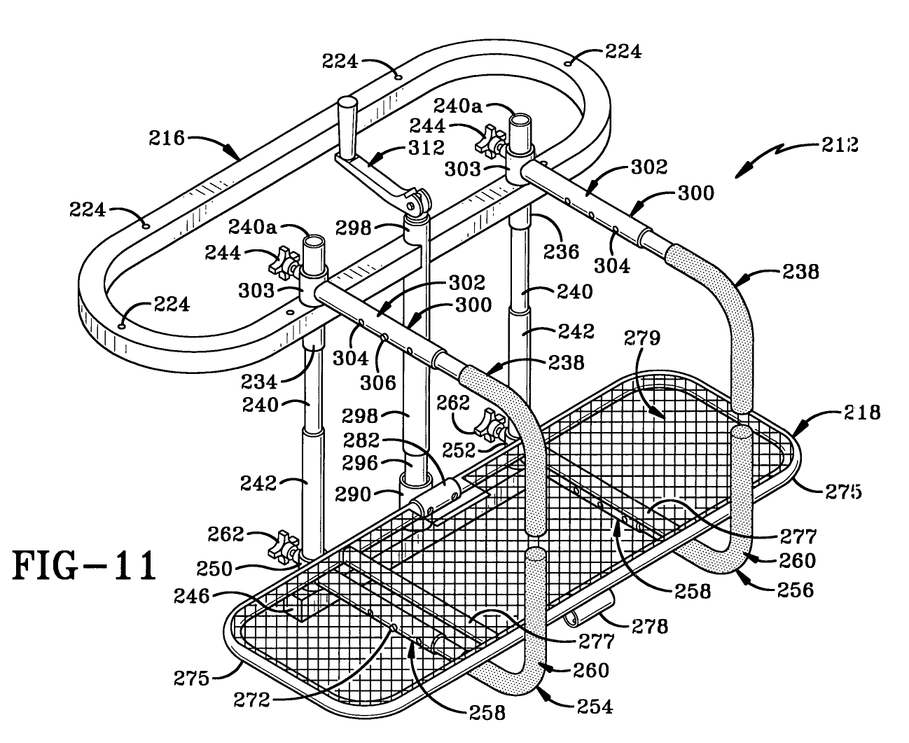

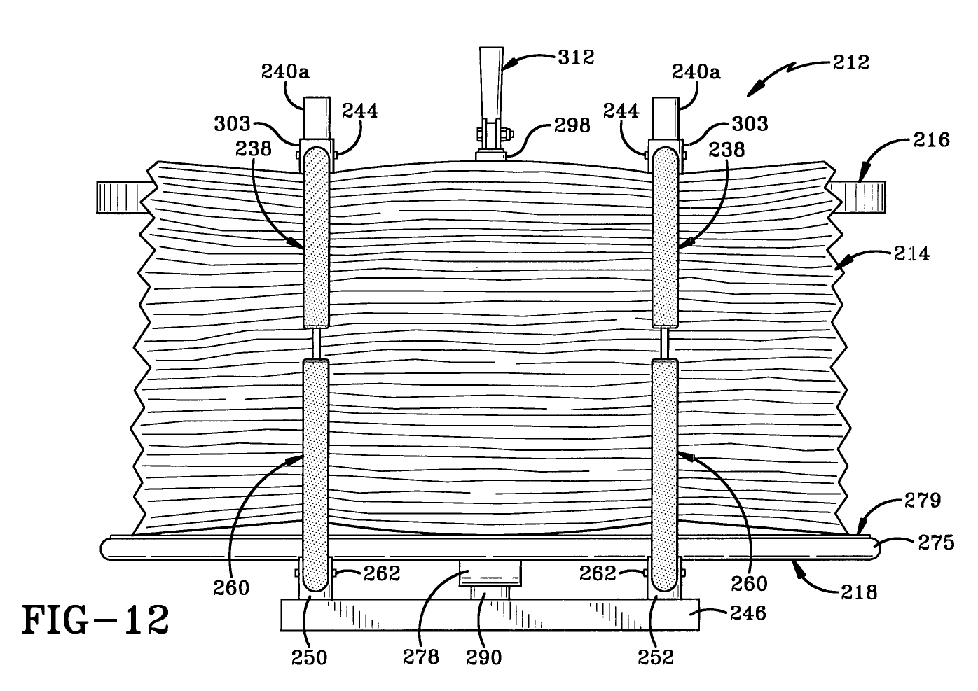

FIGS. 11 and 12 illustrate a second embodiment of cradle that is generally indicated at 212. The components of cradle 212 are substantially identical to that of cradle 12, except that cradle 212 has a platform 218 that includes a peripheral member 275 and a pair of crossbars 277 that support and secure a wire mesh 279 thereon. Furthermore, cradle 212 includes retaining members 300 that each comprises a first section 302 and an arcuate second section 238. Each first section 302 is welded to one of short tubes 303 which is rotatable about the upper ends 240a of tubes 234, 236 in much the same manner as the first sections 258 of support members 254, 256. Each first section 302 includes a plurality of apertures 304 that may selectively receive a projection 306 therein. Projection 306 extends outwardly from the exterior wall of the associated second section 238. The retaining members 300 are therefore adjustable in length in much the same manner as the support members 254, 256. Second sections 238 and 260 may be aligned with each other (FIG. 11) by engaging the projections 272, 306 in the relevant one of the apertures on the first section 258 and first section 302. A load 214 can be placed on platform 218 and be captured between support members 254, 256 and 300, 300 (FIG. 12). The distance between frame 216 and platform 218 is varied by rotating handle 312 in the same manner as for cradle 12.

It will be understood that the telescoping support members 254, 256 can be changed so that the ends of the first sections 258, 302 could be slidably received within the bores of the second sections 260, 238, respectively, to adjust the length of the support members 254, 256.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A cradle for use with a motorized vehicle for lifting and carrying a load; said cradle comprising:
a mounting member adapted to be secured to the motorized vehicle;
a platform adapted to carry the load thereon;
at least one mounting rod connected to the mounting member and to the platform such that the mounting member and platform are disposed a distance apart from each other; and wherein said mounting rod is adjustable in length, whereby adjustment of the length of the mounting rod varies the distance between the mounting member and the platform.

2. The cradle as defined in claim 1, further comprising at least one support member connected to the at least one mounting rod immediately below the platform; said support member extending outwardly away from the mounting rod and under the platform.

3. The cradle as defined in claim 2, wherein the support member is adjustable in length.

4. The cradle as defined in claim 3, wherein the support member comprises a first section that is connected to the mounting rod and a second section that extends outwardly from said first section; and wherein an end of one of said first and second sections is adjustably received within a bore in an end of the other of the first and second sections.

5. The cradle as defined in claim 4, wherein the end of the one of the first and second sections includes a plurality of horizontally spaced apart holes formed in an exterior wall thereof; and the other of the first and second sections includes a projection extending outwardly from an outer wall thereof; and wherein the projection is selectively engageable within any one of the holes to lock the first and second sections together.

6. The cradle as defined in claim 4, wherein the second section of the support member further includes an arcuately shaped region that extends upwardly and outwardly away from the end thereof; and wherein the arcuately shaped region extends upwardly and outwardly beyond a peripheral wall of the platform when the first and second sections are engaged; said arcuately shaped region being adapted to retain the load carried on an upper surface of the platform.

7. The cradle as defined in claim 5, wherein the platform includes a holding mechanism that is complementary sized and shaped to selectively receive the end of the second section therein when the cradle is in a storage position.

8. The cradle as defined in claim 2, further comprising at least a second mounting rod connected to the mounting member a spaced distance from the mounting rod; and wherein the platform is connected to the mounting rod and the support member is connected to the second mounting rod.

9. The cradle as defined in claim 8, further comprising a support bar that extends between the mounting rod and second mounting rod, said support bar being disposed beneath the platform; and wherein the mounting rod and second mounting rod extend upwardly away from the support bar and substantially at right angles thereto.

10. The cradle as defined in claim 9, wherein a first section of the support member is pivotally connected to the support bar; said first section being pivotable between a first position where the first section is disposed substantially parallel to the support bar and a second position where the first section extends outwardly away from the support bar and substantially at right angles thereto.

11. The cradle as defined in claim 1, wherein the platform is pivotably connected to the mounting rod; said platform being pivotable between a first position where an upper surface of the platform abuts the mounting rod; and a second position where the upper surface of the platform is disposed at right angles to the mounting rod.

12. The cradle as defined in claim 11, further comprising a locking mechanism that is selectively engaged to lock the platform in abutting contact with the mounting rod when the platform is in the first position.

13. The cradle as defined in claim 2, further comprising a second support member connected to the mounting rod a spaced distance vertically above the platform; said second support member being adapted to engage a top side of the load to retain the same on an upper surface of the platform.

14. The cradle as defined in claim 13, wherein the second support member includes a second arcuately shaped retaining region that is adapted to engage the top side of the load.

15. The cradle as defined in claim 14, wherein at least a section of the second support member is disposed substantially parallel to at least a section of the first support member.

16. The cradle as defined in claim 15, wherein the second support member is adjustable in length.

17. The cradle as defined in claim 1, wherein the mounting rod further includes an adjustment mechanism for selectively varying the length of the mounting rod.

18. The cradle as defined in claim 17, wherein the mounting rod comprises an upper section and a lower section that telescope one into the other, the upper section having a bore that is substantially coaxial with a bore of the lower section; and wherein the adjustment mechanism comprises:
a threaded rod that extends through the coaxial bores of the upper and lower sections;
a threaded spacer secured to an interior surface of one of the upper and lower sections; and wherein said rod extends through an aperture in the spacer;
an actuating handle connected to a first end of the rod, said handle being selectively rotatable in a first direction, which causes rotation of the rod in the first direction, and being rotatable in a second direction which causes rotation of the rod in the second direction; and when the handle is rotated in the first direction, the length of the mounting rod is extended and when the handle is rotated in the second direction, the length of the mounting rod is reduced.

19. The cradle as defined in claim 1, wherein the mounting member comprises a frame that extends outwardly away from the mounting rod and substantially at right angles thereto.

20. The cradle as defined in claim 19, wherein the platform extends outwardly away from the mounting rod in an opposite direction to the mounting member.

21. A lifting and carrying cradle for a motorized vehicle; said cradle comprising:
a first frame adapted to be connected to the vehicle;
a platform adapted to carry a load on an upper surface thereof;
a pair of spaced apart outer mounting rods extending between the first frame and the platform; such that the platform and first frame extend outwardly away from the mounting rod and in opposite directions relative to each other;
an inner mounting rod extending between the first frame and the platform; said inner and outer mounting rods being selectively adjustable in length;
a pair of spaced apart, adjustable length lower support bars connected to inner and outer mounting rods below the platform, said lower support bars including an arcuate section that extends upwardly beyond a front edge of the platform and is adapted to retain the load on the platform;
a pair of spaced apart adjustable length upper support bars connected to the inner and outer mounting rods a distance above the upper surface of the platform; said upper support bars being adapted to retain a top end of the load on the cradle against movement.
